(19) United States
(12) Patent Application Publication
(10) Pub. No.: US 2024/0411078 A1
(43) Pub. Date: Dec. 12, 2024

(54) POLARIZER, DIFFRACTION GRATING AND META SURFACE FABRICATION VIA ION IMPLANTATION

(71) Applicant: II-VI Delaware, Inc., Wilmington, DE (US)

(72) Inventors: Giovanni Barbarossa, Wilmington, DE (US); Robert Chebi, Wilmington, DE (US); Ramesh Sundaram, Wilmington, DE (US); Jeremy Turcaud, Wilmington, DE (US); Christoph Greiner, Wilmington, DE (US)

(21) Appl. No.: 18/607,870

(22) Filed: Mar. 18, 2024

Related U.S. Application Data
(60) Provisional application No. 63/471,866, filed on Jun. 8, 2023.

(51) Int. Cl. G02B 5/30; B82Y 20/00; B82Y 40/00; G02B 1/00; G02B 1/08

(52) U.S. Cl. CPC G02B 5/3058; B82Y 20/00; B82Y 40/00; G02B 1/002; G02B 1/08

(57) ABSTRACT

This disclosure describes the fabrication of a polarizer, a diffraction grating and a meta surface via ion implantation. The polarizer comprises a plurality of non-conducting areas between a wire grid of conducting wires. The conducting wires may comprise nanowires or nanopillars. The wire grid may be a rectangular grid or a hexagonal grid.

### CROSS REFERENCE TO RELATED APPLICATIONS

This application claims the benefit of and priority to U.S. Provisional Patent Application No. 63/471,866, titled “POLARIZER, DIFFRACTION GRATING AND META SURFACE FABRICATION VIA ION IMPLANTATION,” filed Jun. 8, 2023, the disclosure of which is incorporated herein by reference in its entirety.

### BACKGROUND

Limitations and disadvantages of traditional systems and methods for fabrication will become apparent to one of skill in the art, through comparison of such approaches with some aspects of the present method and system set forth in the remainder of this disclosure with reference to the drawings.

### BRIEF SUMMARY

Systems and methods are provided for the fabrication of a polarizer, a diffraction grating and a meta surface via ion implantation, substantially as illustrated by and/or described in connection with at least one of the figures, as set forth more completely in the claims.

### BRIEF DESCRIPTION OF THE DRAWINGS

FIG. 1A illustrates an embodiment of an optical polarizer fabricated via ion implantation, in accordance with various example implementations of this disclosure.

FIG. 1B illustrates the optical polarizer of FIG. 1A after photo resist removal, in accordance with various example implementations of this disclosure.

FIG. 2 illustrates another embodiment of an optical polarizer fabricated via ion implantation, in accordance with various example implementations of this disclosure.

FIG. 3 illustrates the resulting wire grid polarizer structure, post wet etch removal of the damage portion and resist clean-up, in accordance with various example implementations of this disclosure.

FIG. 4 illustrates a specific example of chemically altering the Al material underneath the open resist trenches for subsequent removal via lift off, in accordance with various example implementations of this disclosure.

FIG. 5 illustrates a specific example of a metal reflection grating generated via the ion implantation based removal process, in accordance with various example implementations of this disclosure.

FIG. 6A illustrates a top view of a meta surface, designed for a 940 nm wavelength, in accordance with various example implementations of this disclosure.

FIG. 6B illustrates a cross-sectional view of the meta surface in FIG. 6A, in accordance with various example implementations of this disclosure.

FIG. 7 illustrates a cross-sectional view of another example meta surface, in accordance with various example implementations of this disclosure.

FIG. 8 illustrates another embodiment of an optical polarizer fabricated via ion implantation, in accordance with various example implementations of this disclosure.

FIG. 9 illustrates another embodiment of an optical polarizer fabricated via ion implantation, in accordance with various example implementations of this disclosure.

FIG. 10 illustrates another embodiment of an optical polarizer fabricated via ion implantation, in accordance with various example implementations of this disclosure.

FIG. 11 illustrates another embodiment of an optical polarizer fabricated via ion implantation, in accordance with various example implementations of this disclosure.

FIG. 12 illustrates another embodiment of an optical polarizer fabricated via ion implantation, in accordance with various example implementations of this disclosure.

FIG. 13 illustrates another embodiment of an optical polarizer fabricated via ion implantation, in accordance with various example implementations of this disclosure.

FIG. 14 illustrates another embodiment of an optical polarizer fabricated via ion implantation, in accordance with various example implementations of this disclosure.

FIG. 15 illustrates another embodiment of an optical polarizer fabricated via ion implantation, in accordance with various example implementations of this disclosure.

FIG. 16 illustrates another embodiment of an optical polarizer fabricated via ion implantation, in accordance with various example implementations of this disclosure.

FIG. 17 illustrates another embodiment of an optical polarizer fabricated via ion implantation, in accordance with various example implementations of this disclosure.

FIG. 18 illustrates another embodiment of an optical polarizer fabricated via ion implantation, in accordance with various example implementations of this disclosure.

FIG. 19 illustrates another embodiment of an optical polarizer fabricated via ion implantation, in accordance with various example implementations of this disclosure.

### DETAILED DESCRIPTION

This disclosure describes a system and method for the fabrication of various types of diffraction gratings, meta surfaces and subwavelength structured diffractive optical elements using multiple different techniques of ion implantation.

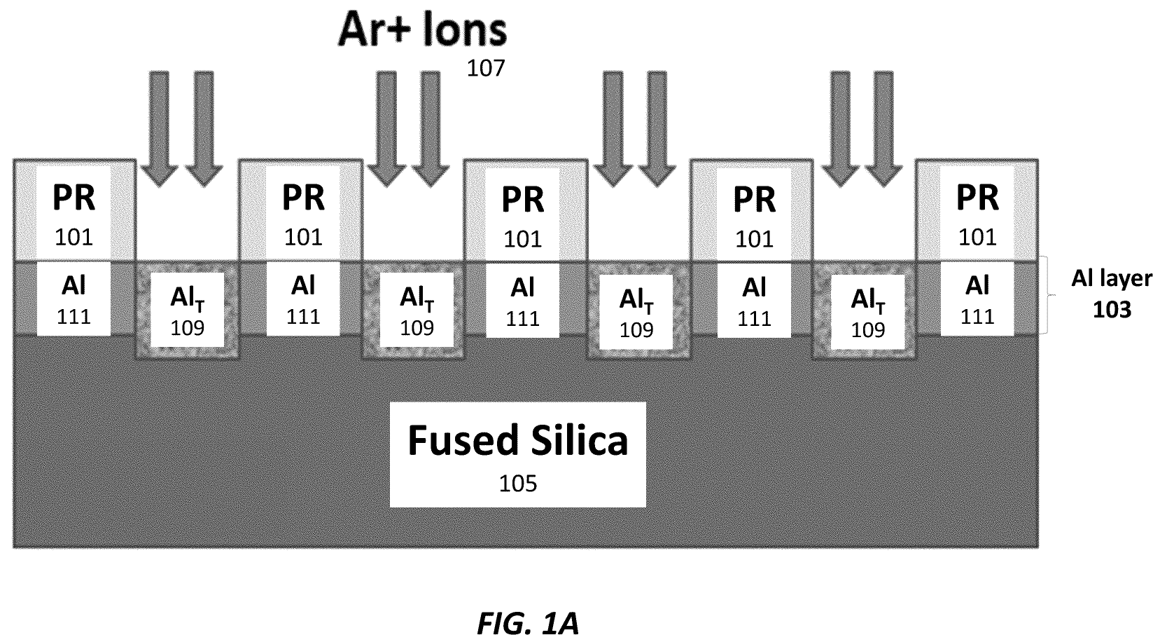

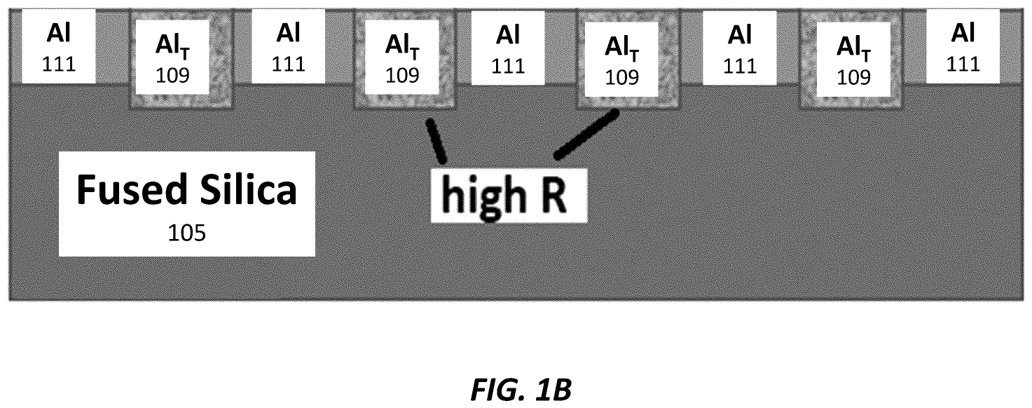

FIG. 1A illustrates an embodiment of an optical polarizer fabricated via ion implantation, in accordance with various example implementations of this disclosure. In FIG. 1A, a metal layer 103, e.g., aluminum (Al), of suitable thickness, e.g., 500 nm, is deposited on a substrate 105 of material that is adequately transparent at the wavelength of interest. With a polarizer operation in the visible (>400 nm wavelength) to near infrared (<2 μm wavelength) wavelength band, the substrate 105 may be fused silica, but other suitably transparent materials are possible. A photoresist (PR) 101 is deposited and patterned on the Al layer 103 into a line space pattern with a period suitably small compared to the wavelength range of interest, such that no diffraction occurs.

The structure is then subjected to ion implantation 107, e.g. with Ar or other suitable ions, wherein the implanted ions are made to propagate through the open photoresist trenches into and beyond the Al layer 103 into the substrate 105. This process can occur at room temperature. As the Ar ions 107 propagate through the Al 103, damage occurs in the metal that increases its resistivity to a high or even infinite value while at the same time transforming the formerly reflecting Al layer 103 into transparent Al (Al_{T}) 109 at the wavelength range of interest. A wire grid polarizer is thereby generated comprising non-conducting/high resistivity Al_{T} areas 109 (damaged, under open resist spaces) between a periodic line space pattern of conducting Al nano wires 111 (undamaged regions).

FIG. 1B illustrates the optical polarizer of FIG. 1A after photo resist removal, in accordance with various example implementations of this disclosure.

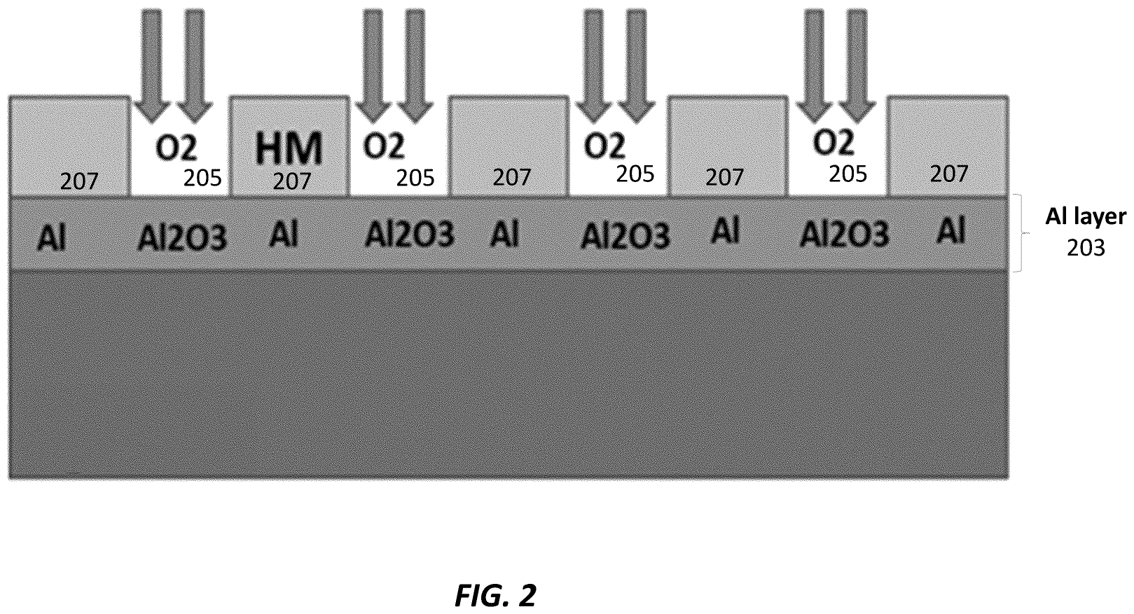

FIG. 2 illustrates another embodiment of an optical polarizer fabricated via ion implantation, in accordance with various example implementations of this disclosure. In FIG. 2, the polarizer's Al layer 203 is implanted with oxygen 205 (dimer or mono atomic oxygen). The method can rely on a resist mask for room temperature implantation, but for any elevated temperatures required in an implantation or post processing step, e.g. a post implantation anneal, a hard mask (HM) 207 such as SiN or carbon is required. Either during the implantation process itself or in a subsequent anneal step, the oxygen implanted portions of the Al layer are converted to Al2O3. The Al/Al2O3 line space structure can, when properly designed, function as a polarizer.

When the aluminum layer 203 is ion implanted with N2 or N instead of O2/O, aluminum nitride can be formed instead of AlxOy, leading to a different polarizer embodiment.

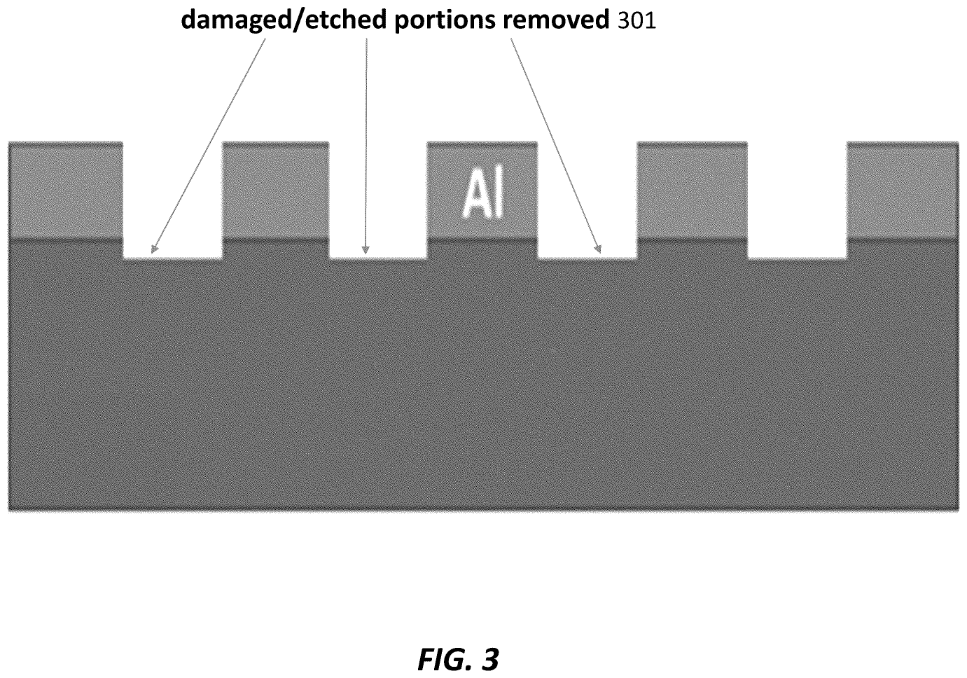

In a different approach, specific ions may be implanted in the aluminum that induce physical damage or chemical modification, allowing a subsequent complete selective removal of the damaged or chemically altered portion, e.g. by a wet etch process. FIG. 3 illustrates the resulting wire grid polarizer structure, post wet etch removal of the damage portion 301 and resist clean-up, in accordance with various example implementations of this disclosure.

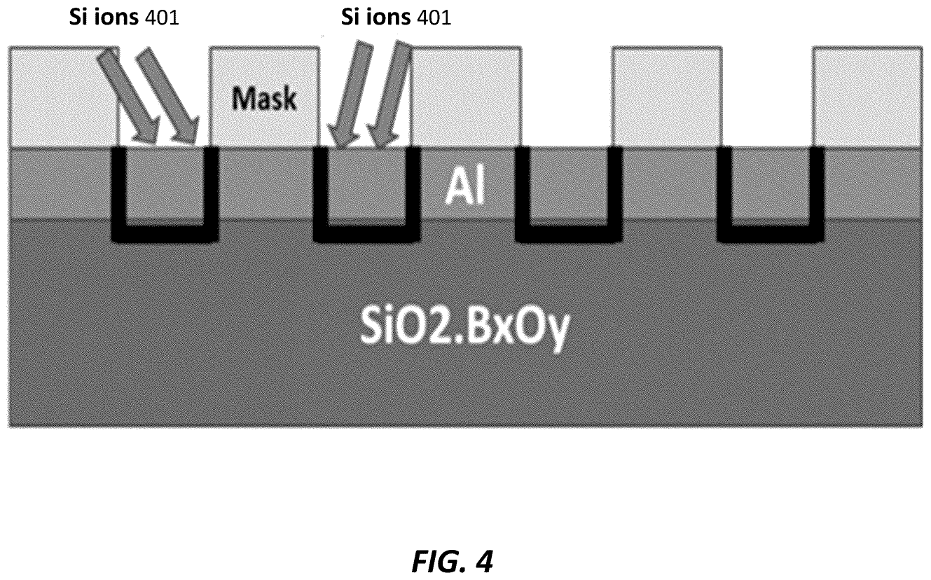

FIG. 4 illustrates a specific example of chemically altering the Al material underneath the open resist trenches for subsequent removal via lift off, in accordance with various example implementations of this disclosure. Implantation, e.g. by Si ions 401 occurs at an angle, chemically altering the Al to form a AlxSiy compound (black regions) which may be removable by wet etch, e.g. using fluoride based or other chemistries. Al enclosed by the converted regions will simply be lifted off in the process, creating the structure shown in FIG. 3. It should be noted that the implantation angle (shown by arrows) can be changed and used to affect, e.g. narrow or broaden, the dimensions of the remaining lines. This technique is useful where the desirable Al lines are thinner than those dictated by the possibly limited range of available resist dimensions.

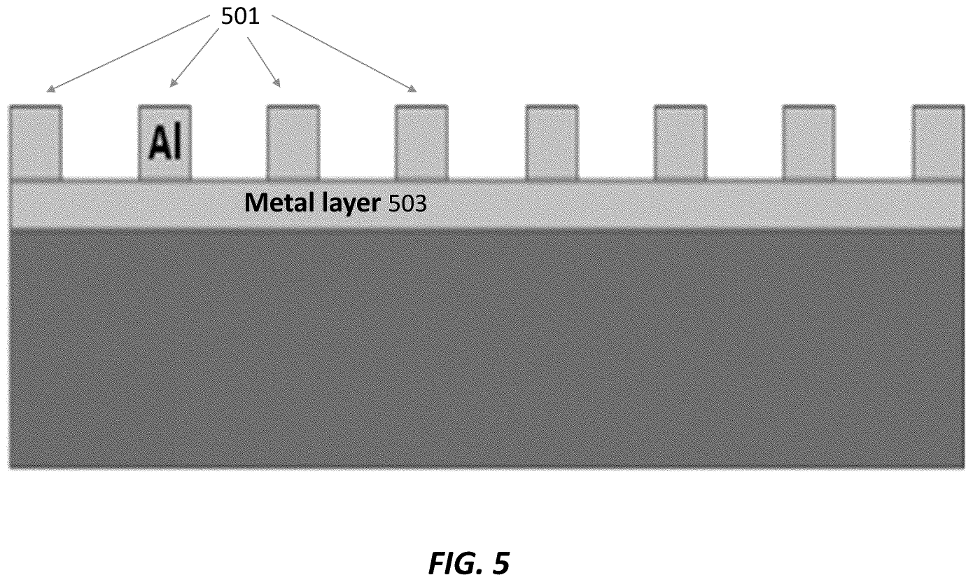

FIG. 5 illustrates a specific example of a metal reflection grating generated via the ion implantation based removal process, in accordance with various example implementations of this disclosure. If the layer to be implanted is Al or another metal and the period of the pattern is large enough to allow diffraction, a metal reflection grating 501 can be designed and fabricated, provided that an adequately thick metal layer 503 remains underneath the lifted off portions of the trench.

The previous discussion focused on the creation of polarizers and diffractives based on the alteration, through removal or chemical/physical modification of conductive layers. Similar consideration applies, if the layer to be treated by ion implantation is a dielectric material, transparent at the wavelength of interest. Through ion implantation enabled material alteration and subsequent removal transmission gratings may be created.

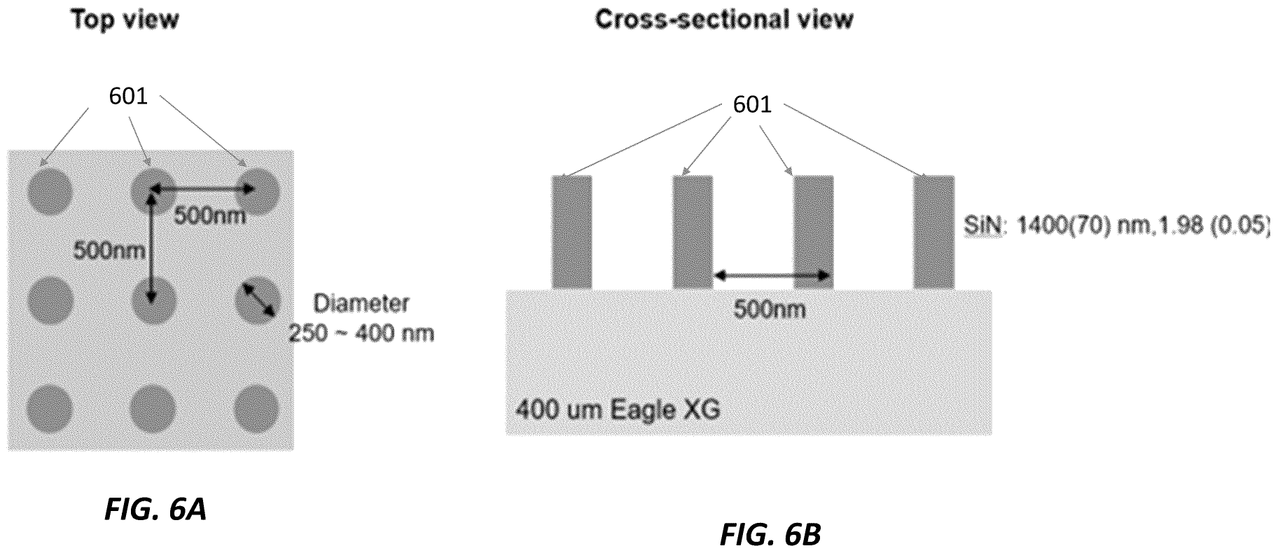

FIG. 6A illustrates a top view of a meta surface, designed for a 940 nm wavelength, in accordance with various example implementations of this disclosure. FIG. 6B illustrates a cross-sectional view of the meta surface in FIG. 6A, in accordance with various example implementations of this disclosure. In FIGS. 6A and 6B, an appropriately designed two-dimensional resist pattern, e.g. nano pillars 601 on a hexagonal or rectangular grid with subwavelength dimension, is transferred into a dielectric layer via ion implantation. A meta surface material may be generated that enables the design of, for example, lenses, dot generators etc.

In FIGS. 6A and 6B, the meta surface structure is created by defining subwavelength scale areas of a high refractive index and a low refractive index. Ambient medium (air, low index regions) filled unit cells containing high refractive index nanopillars 601, through lateral feature size (diameter) control, create arbitrary phase delays that may be designed into global phase surfaces providing desired functions such as lensing, splitting etc. Material removal creating the air-filled portions of the subwavelength scaled unit cells may proceed as discussed above in reference to FIG. 4.

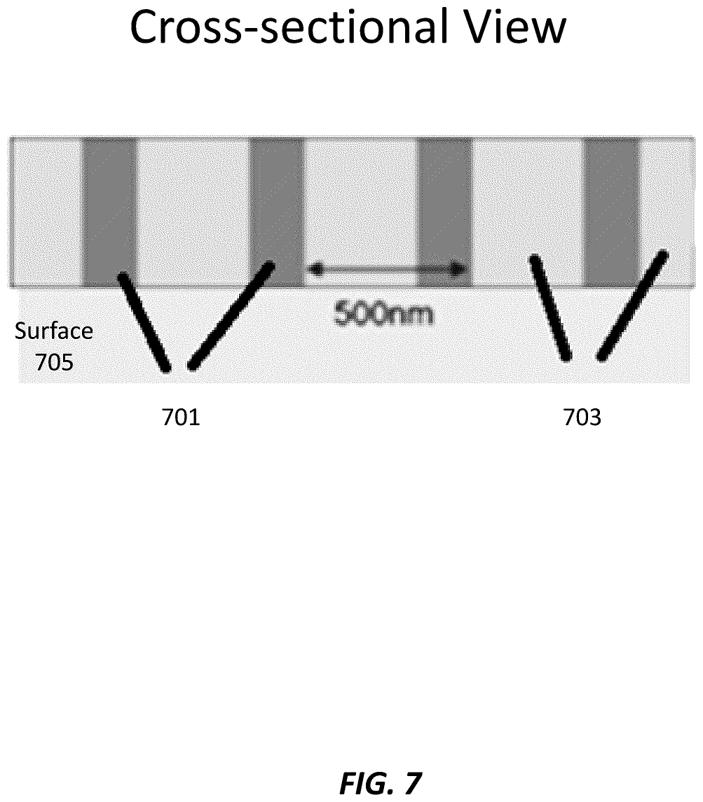

Alternatively, following material alteration (specifically the alteration of the optical material properties such as refractive index), meta surfaces with high index regions 601 (such as the nano pillars in FIG. 6) may be created through an implantation of appropriate ions such as Ge etc. in a suitable host dielectric layer such a silicon dioxide. FIG. 7 illustrates a cross-sectional view of another example meta surface, in accordance with various example implementations of this disclosure.

The meta surface of FIG. 7 is created by the implantation of ions into openings 703 in a (negative) photo resist. The photo resist defines the cross sections of the high index nanofeatures 701. As index contrasts between thus generated nanostructures in a solid host material are typically lower compared to air, the host material meta surface layer 705 thickness may require appropriate adjustment.

A wire grid polarizer may be formed though ion-implantation into a film using a patterned periodic grating mask. In one embodiment, the deposited film is conductive and the implanted area is resistive, such as an aluminum film implanted with oxygen or nitrogen ions. The resistivity of the implanted region can be controlled by the dose of the implant and the penetration depth into the film can be controlled by the implantation energy.

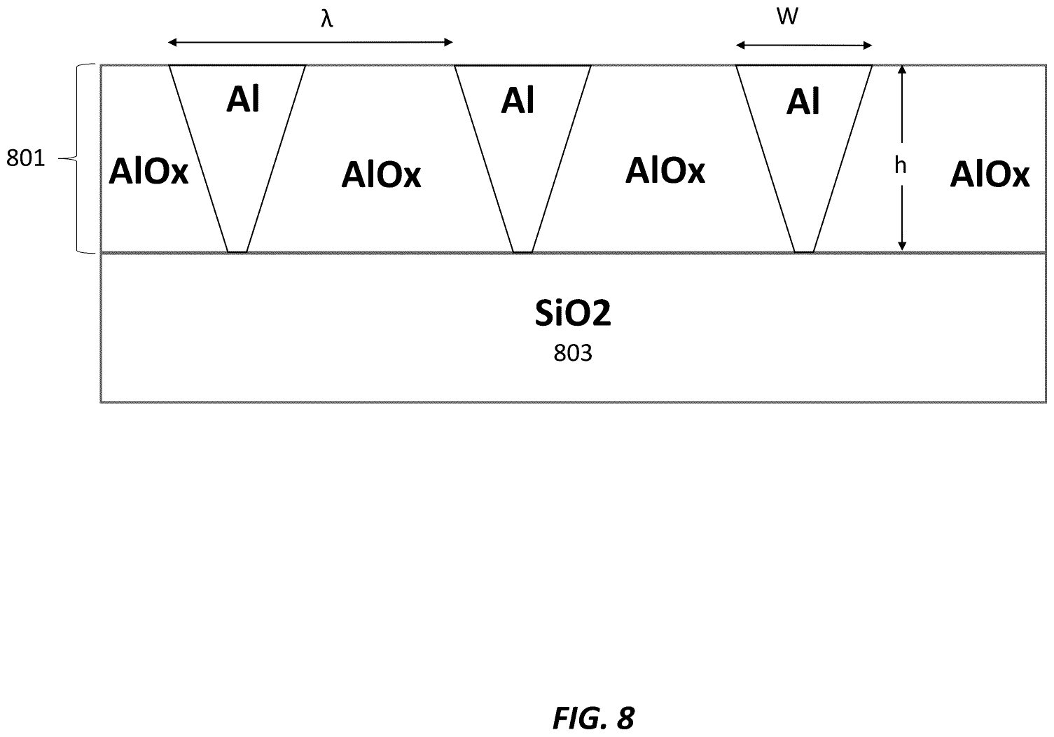

FIG. 8 illustrates another embodiment of an optical polarizer fabricated via ion implantation, in accordance with various example implementations of this disclosure. In FIG. 8, a multi-stage implantation targeted at different energies and depths (h) is used to create a single layer 801 of an Al grating layer within an aluminum oxide (AlOx) film on a silicon dioxide (SiO2) substrate 803.

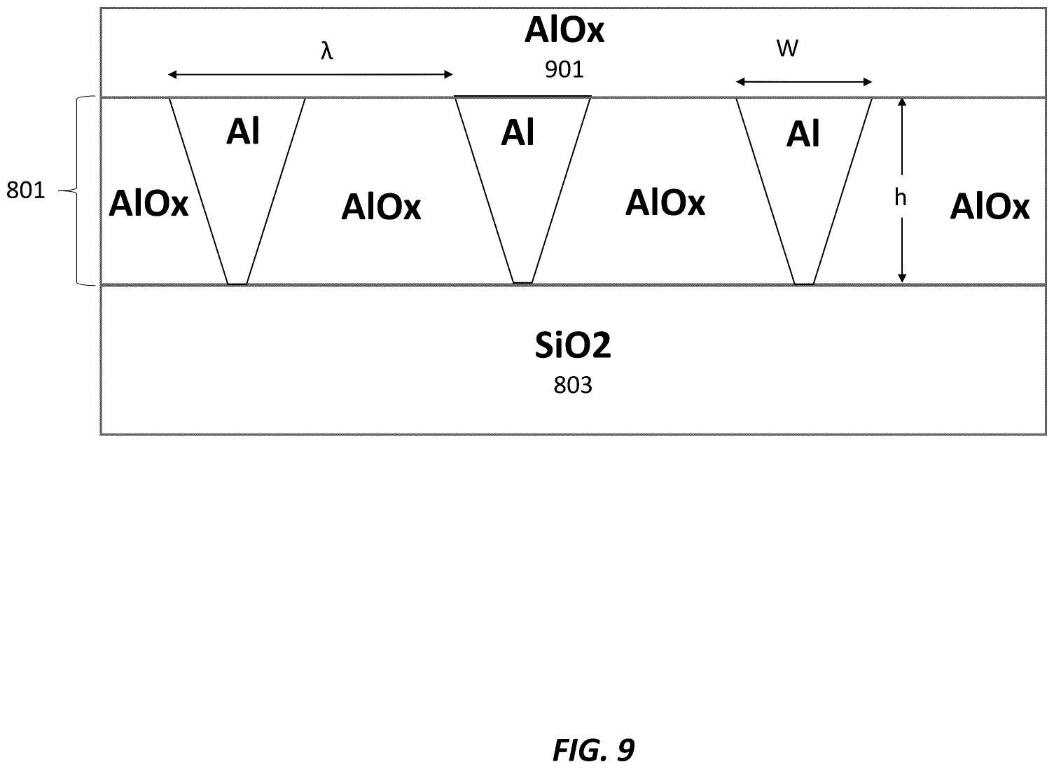

FIG. 9 illustrates another embodiment of an optical polarizer fabricated via ion implantation, in accordance with various example implementations of this disclosure. In FIG. 9, the structure of FIG. 8 is encapsulated with a dielectric film 901. The dielectric 901 may be spun on or deposited using a technique such as chemical vapor deposition (CVD).

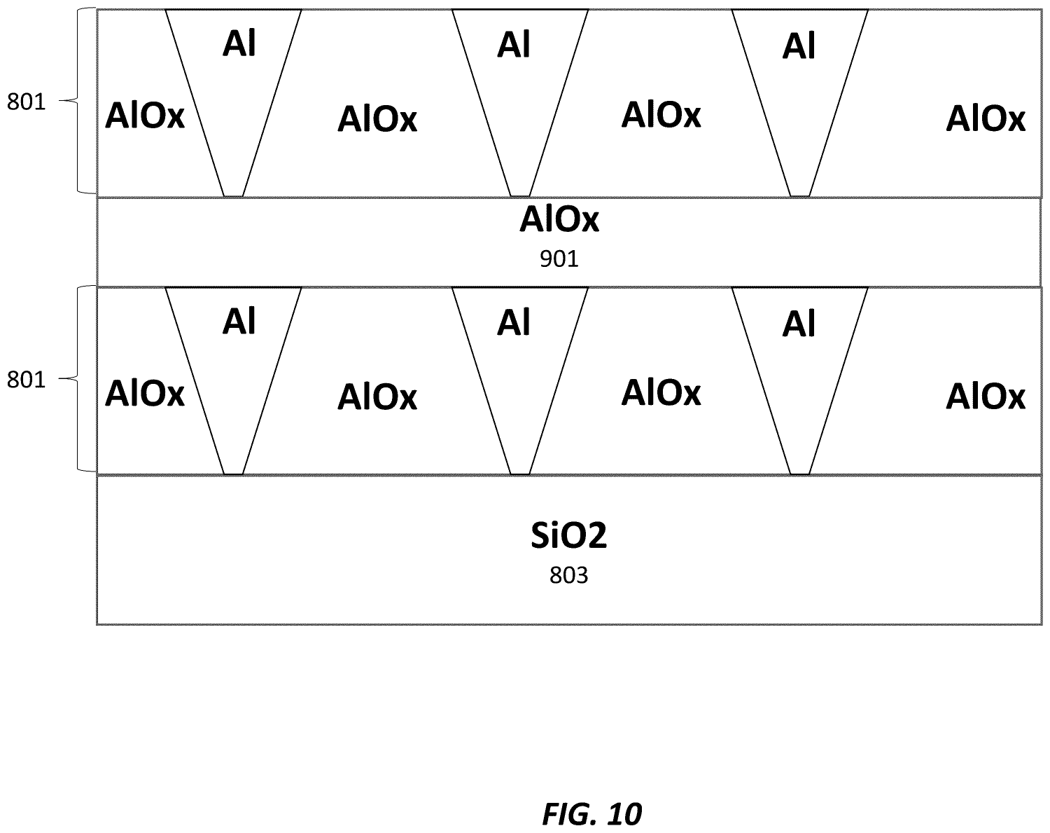

FIG. 10 illustrates another embodiment of an optical polarizer fabricated via ion implantation, in accordance with various example implementations of this disclosure. In FIG. 10, another layer 801 is added to the structure of FIG. 9. AlOx film deposition followed by Al implantation may be repeated multiple times to create multiple layers 801.

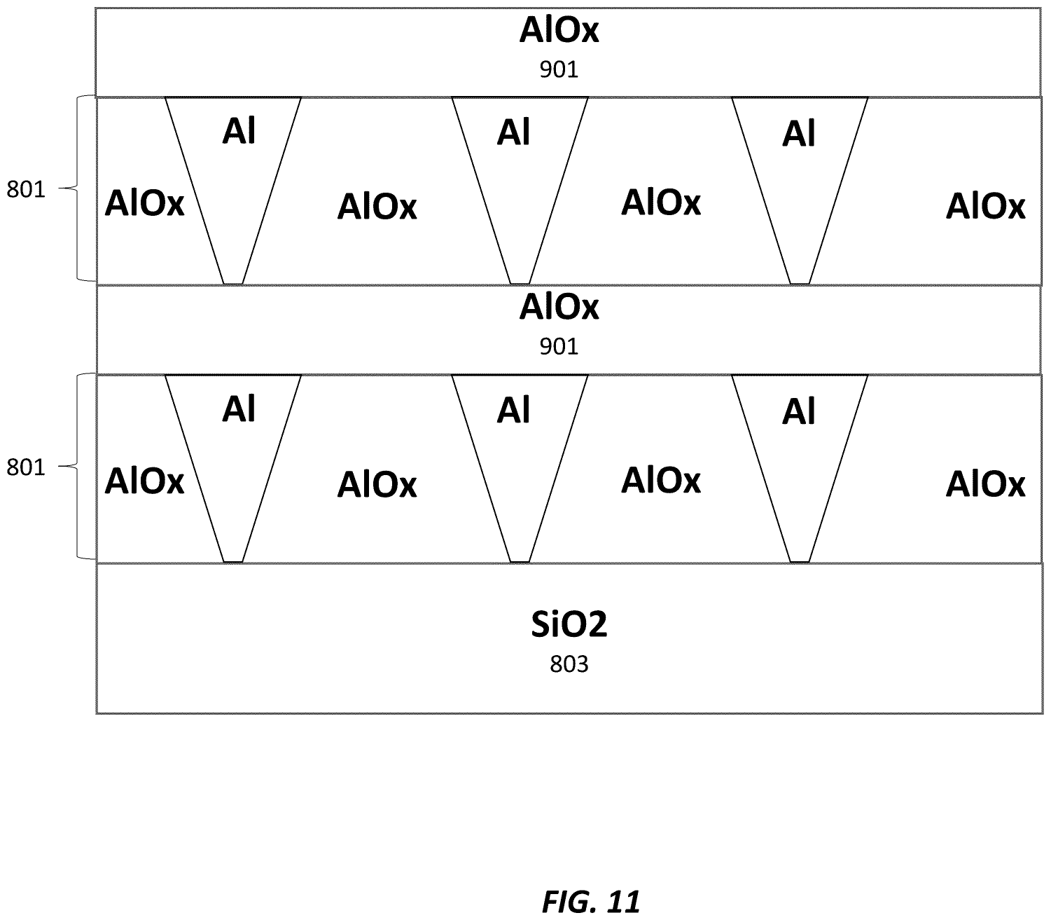

FIG. 11 illustrates another embodiment of an optical polarizer fabricated via ion implantation, in accordance with various example implementations of this disclosure. In FIG. 11, an encapsulant layer 901 is added to the structure of FIG. 10. There may be one or more encapsulant layers 901.

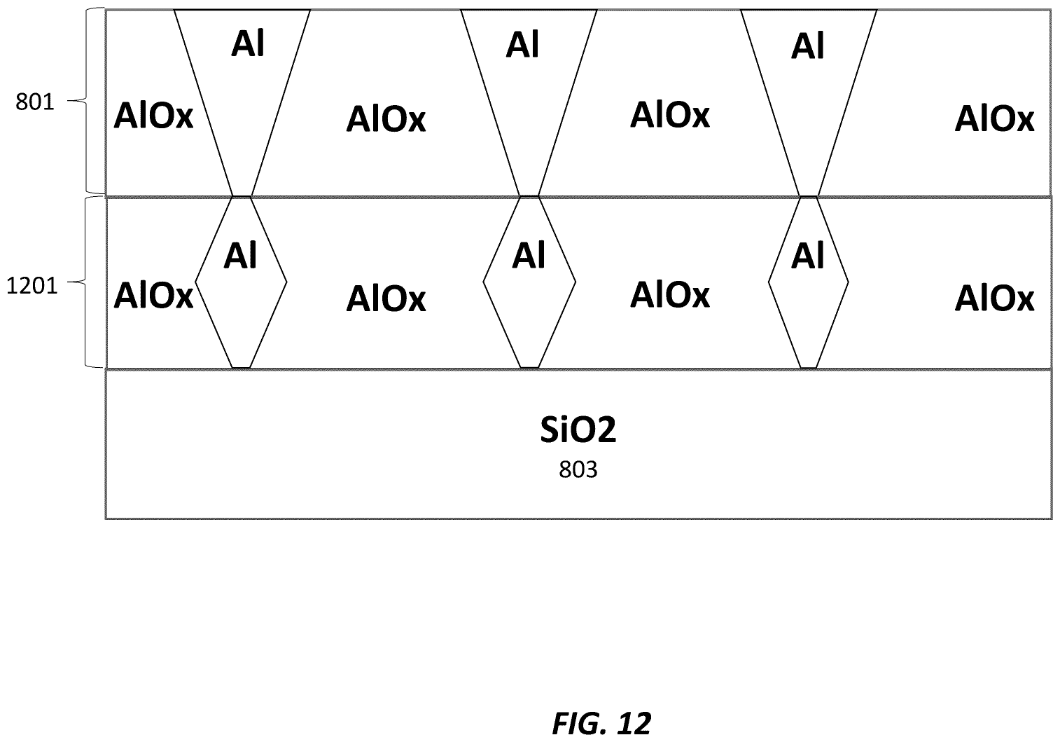

FIG. 12 illustrates another embodiment of an optical polarizer fabricated via ion implantation, in accordance with various example implementations of this disclosure. In FIG. 12, the AlOx film deposition followed by Al implantation is repeated consecutively multiple times to create multiple layers 801, 1201. The implantation from the top layer 801 may diffuse into the underlying layer 1201 during the implantation process.

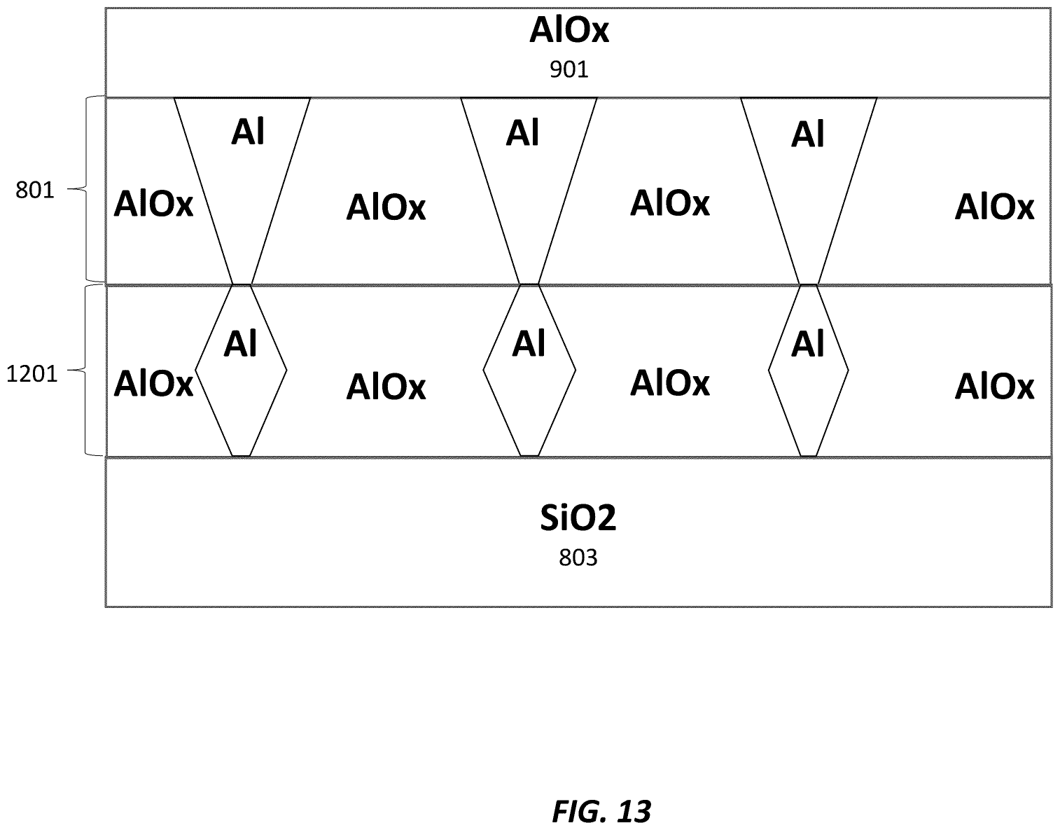

FIG. 13 illustrates another embodiment of an optical polarizer fabricated via ion implantation, in accordance with various example implementations of this disclosure. In FIG. 13, an encapsulant layer 901 is added to the structure of FIG. 12.

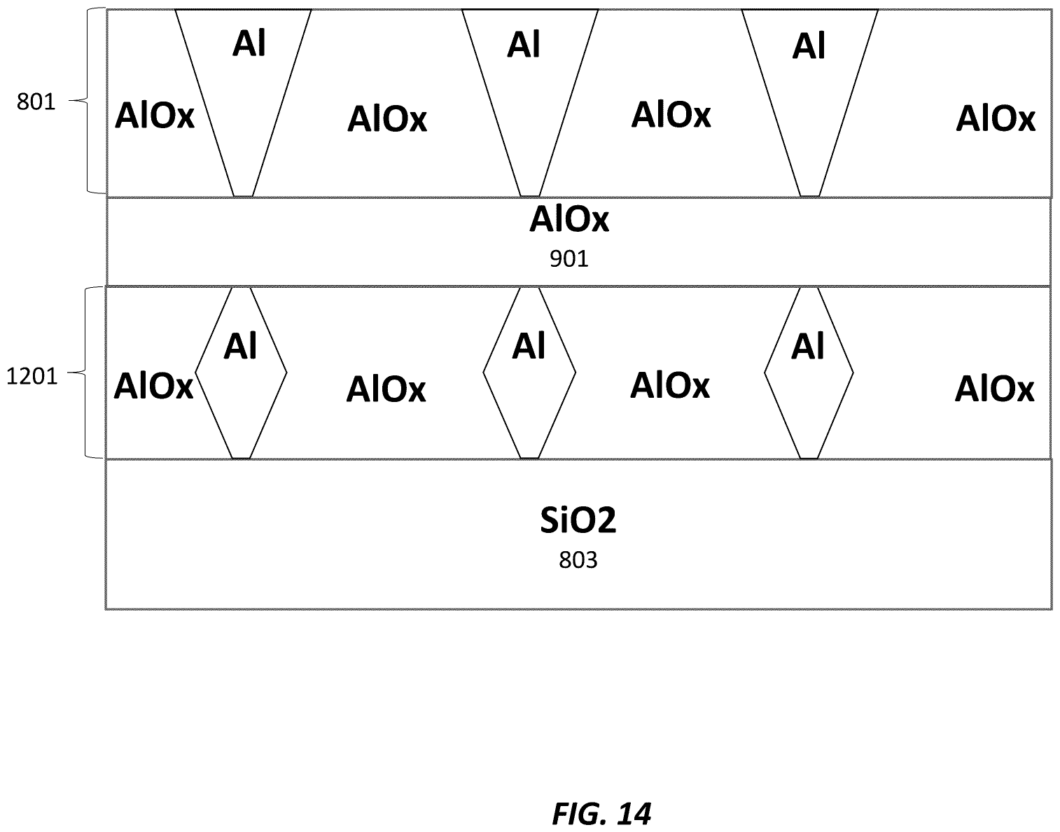

FIG. 14 illustrates another embodiment of an optical polarizer fabricated via ion implantation, in accordance with various example implementations of this disclosure. In FIG. 14, an encapsulant layer 901 is placed between multiple layers 801, 1201.

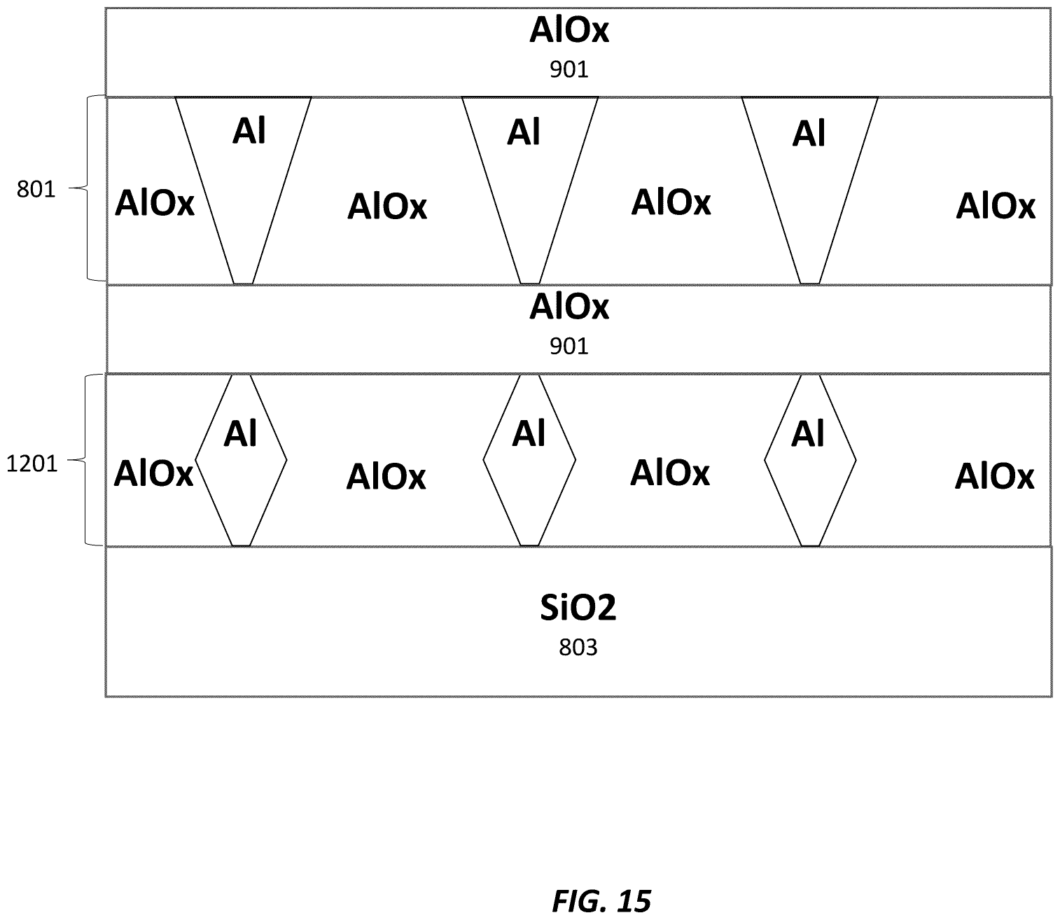

FIG. 15 illustrates another embodiment of an optical polarizer fabricated via ion implantation, in accordance with various example implementations of this disclosure. In FIG. 15, an encapsulant layer 901 is added to the structure of FIG. 14.

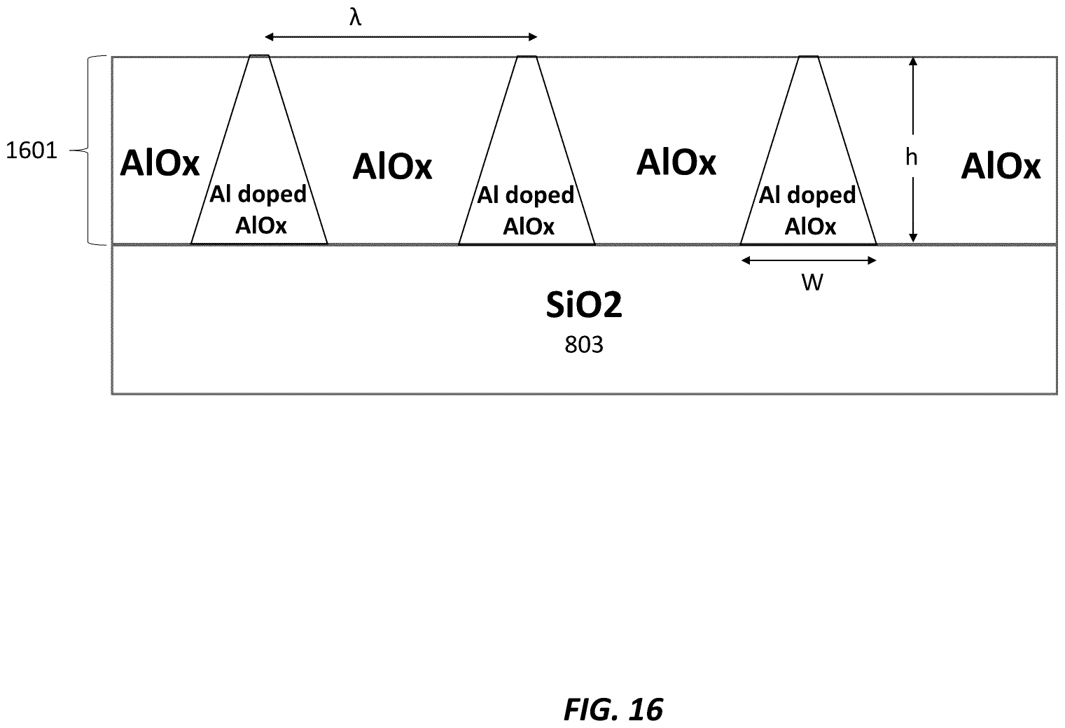

FIG. 16 illustrates another embodiment of an optical polarizer fabricated via ion implantation, in accordance with various example implementations of this disclosure. In an alternative process, a dielectric film is deposited and a grating is formed though ion-implantation of a dopant using a patterned periodic grating mask. A multistage implantation is used to create a layer 1601 comprising an alternation of doped and undoped regions.

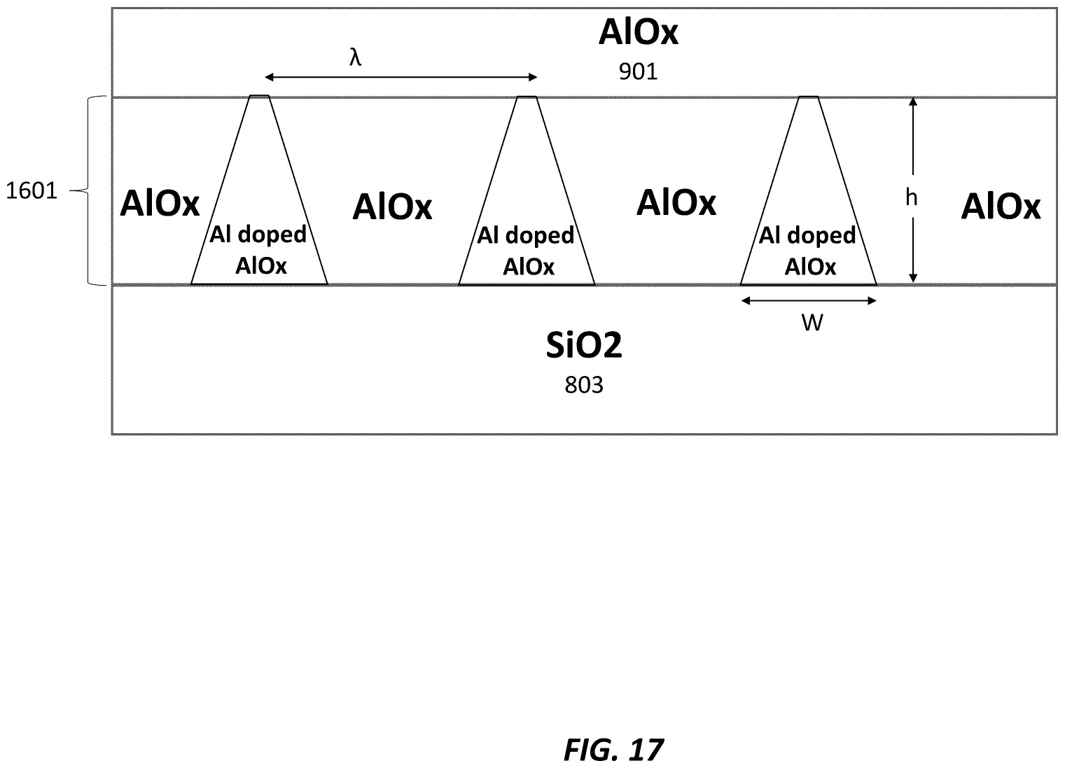

FIG. 17 illustrates another embodiment of an optical polarizer fabricated via ion implantation, in accordance with various example implementations of this disclosure. In FIG. 17, an encapsulant layer 901 of dielectric film is added to the structure of FIG. 16.

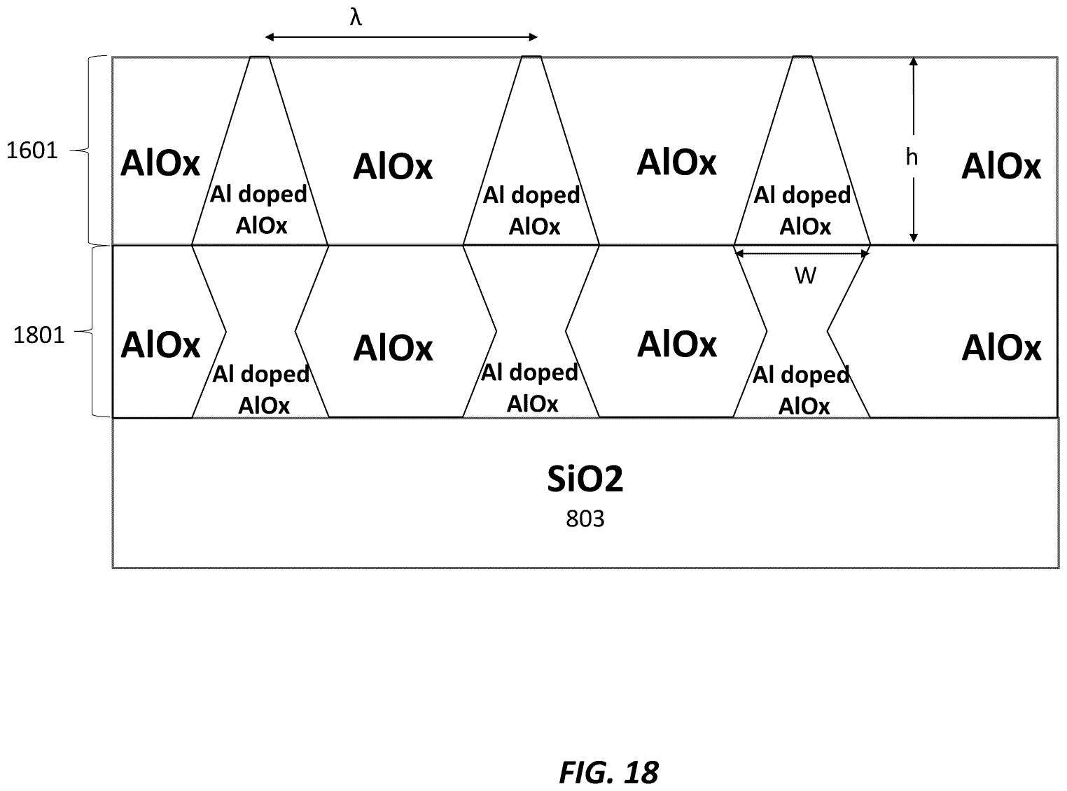

FIG. 18 illustrates another embodiment of an optical polarizer fabricated via ion implantation, in accordance with various example implementations of this disclosure. In FIG. 18, the process described regarding FIG. 16 is repeated consecutively multiple times to create multiple layers 1601, 1801. The implantation from the top layer 1601 may diffuse into the underlying layer 1801 during the implantation process.

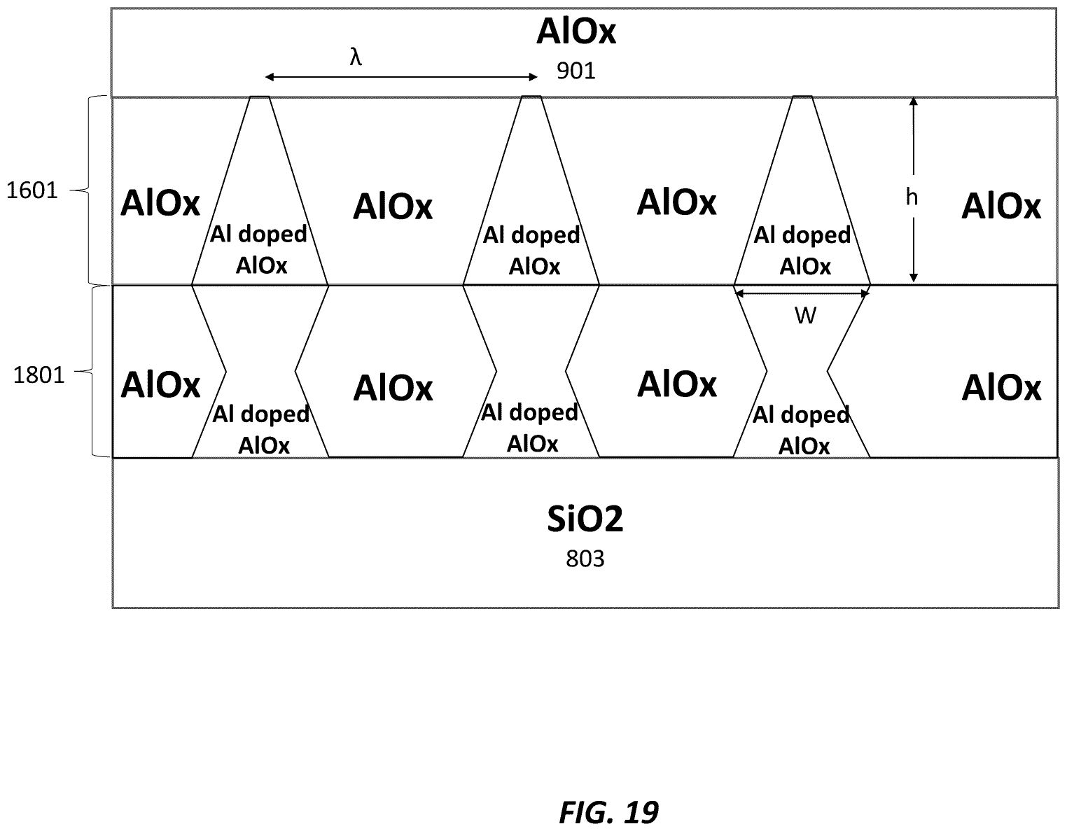

FIG. 19 illustrates another embodiment of an optical polarizer fabricated via ion implantation, in accordance with various example implementations of this disclosure. In FIG. 19, an encapsulant layer 901 is added to the structure of FIG. 18. Any embodiment (e.g., as illustrated in FIGS. 8-19) may comprise antireflective coatings in the deposition to help mitigate transmission losses.

As used herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As used herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As used herein, the term “exemplary” means serving as a non-limiting example, instance, or illustration. As used herein, the terms “e.g.,” and “for example” set off lists of one or more non-limiting examples, instances, or illustrations. As used herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.). As used herein, the term “based on” means “based at least in part on.” For example, “x based on y” means that “x” is based at least in part on “y” (and may also be based on z, for example).

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A structure, comprising:
a polarizer comprising a plurality of non-conducting areas between a grid of conducting elements.

2. The structure of claim 1, wherein the conducting elements comprise nanowires.

3. The structure of claim 1, wherein the conducting elements comprise nanopillars.

4. The structure of claim 1, wherein the grid is a hexagonal grid.

5. The structure of claim 1, wherein the grid is operably coupled to a substrate.

6. The structure of claim 5, wherein the substrate comprises a silica compound.

7. The structure of claim 5, wherein the substrate is transparent at wavelengths of interest.

8. The structure of claim 7, wherein the wavelengths of interest are greater than 400 nm and less than 2 μm.

9. The structure of claim 1, wherein the grid comprises aluminum.

10. The structure of claim 1, wherein the non-conducting areas comprise transparent aluminum.

11. The structure of claim 1, wherein the non-conducting areas are generated by subjecting a conducting material to ion implantation.

12. The structure of claim 11, wherein the ion implantation comprises the use of argon, oxygen, germanium and/or nitrogen.

13. The structure of claim 11, wherein the grid is generated by covering a conductive material with photoresist in a periodic line space pattern during the ion implantation.

14. The structure of claim 1, wherein the non-conducting areas comprise aluminum nitride.

15. The structure of claim 1, wherein the non-conducting areas are generated by implanting silicon ions at an angle to produce an aluminum silicon compound.

16. The structure of claim 15, wherein the aluminum silicon compound is removed via a lift off process.

17. The structure of claim 15, wherein the aluminum silicon compound is removed via a wet etching.

18. The structure of claim 15, wherein the angle determines a dimension of the conducting elements.

19. The structure of claim 1, wherein the grid is operably coupled to a metal layer.

20. The structure of claim 1, wherein:
the grid comprises a plurality of pillars, and
a distance between each pillar is determined according to a wavelength of interest.
